(19) United States
(12) Patent Application Publication
(10) Pub. No.: US 2017/0198125 A1
(43) Pub. Date: Jul. 13, 2017

(54) POLYPROPYLENE COMPOSITIONS

(71) Applicant: BASELL POLIOLEFINE ITALIA S.R.L., MILANO (IT)

(72) Inventors: TAKESHI TSUKAHARA, KAWASAKI (JP); NOBUYUKI TSURUMI, KAWASAKI (JP); SHITOSHI KANNO, KAWASAKI (JP); KUNIO YAMAMOTO, KAWASAKI (JP); TAKESHI NAKAJIMA, KAWASAKI (JP)

(73) Assignee: BASELL POLIOLEFINE ITALIA S.R.L., MILANO (IT)

(21) Appl. No.: 15/321,321

(22) PCT Filed: Jun. 8, 2015
(86) PCT No.: PCT/EP2015/062713

§ 371 Date: Dec. 22, 2016

(30) Foreign Application Priority Data
Jul. 1, 2014 (EP) 14175166.9

(51) Int. Cl. C08L 23/12

(52) U.S. Cl. CPC C08L 23/12; C08L 2205/02; C08L 2205/24

(57) ABSTRACT

The present disclosure generally relates to a heterophasic polypropylene composition comprising 68-76% by weight of a propylene homopolymer or copolymer matrix, 24-32% by weight of an ethylene-propylene copolymer, and a nucleating agent. In some embodiments, the composition has an intrinsic viscosity of the xylene soluble (XSIV) fraction at room temperature of up to 1.3 dl/g and a melt flow rate (230° C., 2.16 kg) of 30 to 70 g/10 min. The compositions disclosed herein can be used in molded articles, using techniques such as thin wall injection molding, that are endowed with excellent impact behavior.

### FIELD OF THE INVENTION

The present disclosure relates to polypropylene compositions comprising a heterophasic propylene polymer and a nucleating agent. In addition, the disclosure relates to a method for the preparation of polypropylene compositions. The disclosure further relates to molded articles, including thin walled injection molded articles, obtained from the polypropylene compositions.

### BACKGROUND OF THE INVENTION

There is a continual need to improve the impact resistance of polypropylene. Impact resistance is not the only property that must be considered in preparing polypropylene compositions. For example, the market demands that the overall balance of properties must be satisfactory for a broad range of applications. Accordingly, there is a need for polypropylene compositions that have an appropriate balance of properties that include an improved impact resistance.

### SUMMARY OF THE INVENTION

The present disclosure generally relates to a polypropylene composition comprising:
(a) 68-76 wt. %, based upon the total weight of components (a) to (c), of a first polymer component comprising a propylene homopolymer or a copolymer of propylene, wherein the copolymer of propylene contains up to 1.2 wt. % of ethylene derived units;
(b) 24-32 wt. %, based upon the total weight of components (a) to (c), of a second polymer or copolymer component comprising 72 to 86 wt. % ethylene derived units and 14 to 28 wt. % propylene derived units; and
(c) a nucleating agent;
wherein the polypropylene composition has an intrinsic viscosity of the xylene soluble fraction (XSIV) at room temperature of up to 1.3 dl/g and a melt flow rate (MFR), measured at 230° C. and 2.16 kg, from 30 to 70 g/10 min.

In some embodiments, the nucleating agent is present in the polypropylene composition disclosed herein in amount from 0.01 to 2 wt. %, based upon the total weight of components (a) to (c). In some embodiments, the nucleating agent is present in an amount from 0.05 to 1 wt. %, based upon the total weight of components (a) to (c). In further embodiments, the nucleating agent is present in an amount from 0.1 to 0.5 wt. %, based upon the total weight of components (a) to (c).

The compositions disclosed herein are endowed with a valuable combination of properties, including impact resistance (in terms of puncture resistance) and transparency (in terms of haze).

In some embodiments, the polypropylene compositions disclosed herein may be prepared by a sequential polymerization. The sequential polymerization process used to prepare the polypropylene compositions may comprise at least two sequential polymerization steps. In certain embodiments, the first polymer component (a) is prepared before the second polymer component (b). In some embodiments, in the first polymerization step, the first polymer component (a) is formed and, in a subsequent polymerization step, the second polymer component (b) is formed. In additional embodiments, the second and, if present, subsequent steps are performed in the presence of the resulting polymer and the catalyst used in the preceding step. In some embodiments, the catalyst is added only in the first step since its activity is such that it is still active for all subsequent steps.

In another aspect of the disclosure, a process for the preparation of the polypropylene compositions disclosed herein is provided, where the process comprising at least two sequential polymerization stages with each subsequent polymerization being conducted in the presence of the polymeric material formed in the immediately preceding polymerization reaction, wherein the polymerization stage of propylene to the polymer component (a) is carried out in at least one stage, then at least one copolymerization stage comprising mixtures of ethylene with propylene to the polymer component (b) is carried out. The polymerization stages may be carried out in the presence of a stereospecific Ziegler-Natta catalyst.

According to a further aspect, the disclosure provides for a molded article obtained from a propylene polymer composition comprising:
(a) 68-76 wt. %, based upon the total weight of components (a) to (c), of a first polymer component comprising a propylene homopolymer or a copolymer of propylene, wherein the copolymer of propylene contains up to 1.2 wt. %, of ethylene derived units;
(b) 24-32 wt. %, based upon the total weight of components (a) to (c), of a second polymer component comprising a copolymer comprising 72 to 86 wt. %, ethylene derived units and 14 to 28 wt. %, propylene derived units; and
(c) a nucleating agent;
wherein the composition has an intrinsic viscosity of the xylene soluble fraction (XSIV) at room temperature of up to 1.3 dl/g and a melt flow rate (MFR), measured at 230° C. and 2.16 kg, from 30 to 70 g/10 min.

According to an additional embodiment, the present disclosure provides for a container comprising a propylene polymer composition comprising:
(a) 68-76 wt. %, based upon the total weight of components (a) to (c), of a first polymer component comprising a propylene homopolymer or a copolymer of propylene, wherein the copolymer of propylene contains up to 1.2 wt. %, of ethylene derived units;
(b) 24-32 wt. %, based upon the total weight of components (a) to (c), of a second polymer component comprising a copolymer comprising 72 to 86 wt. %, ethylene derived units and 14 to 28 wt. %, propylene derived units; and
(c) a nucleating agent;
wherein the composition has an intrinsic viscosity of the xylene soluble fraction (XSIV) at room temperature of up to 1.3 dl/g and a melt flow rate (MFR), measured at 230° C. and 2.16 kg, from 30 to 70 g/10 min.

### DETAILED DESCRIPTION OF THE INVENTION

In some embodiments, the first polymer component (a) is present in an amount from 68 to 75% by weight, based upon the total weight of components (a) to (c).

In certain embodiments, the second polymer component (b) is present in amount from 25 to 32% by weight, based upon the total weight of components (a) to (c).

In additional embodiments, nucleating agents are added to the polypropylene composition to improve its physical and/or optical properties.

Examples of nucleating agents that can be used in the different objects of the present invention are:
sodium benzoate,
talc,
1,3:2,4-dibenzylidenesorbitol,
1,3:2,4-bis-(4-methylbenzylidene) sorbitol,
1,3:2,4-bis-(3,4-dimethylbenzylidene) sorbitol,
1,2,3-trideoxy-4,6:5,7-bis-O-[(4-propylphenyl)methylene]-nonitol,
1,3,5-tris(2,2-dimethylpropionylamino)benzene, and
phosphoric esters of the formula:

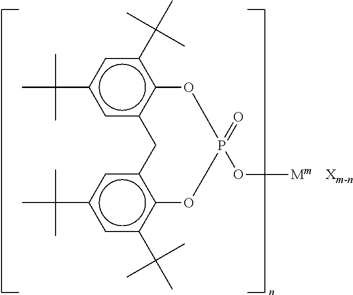

wherein M is aluminum, X is a hydroxy group, m is 3, and n is 1 or 2, that may be sold under the trade name ADK STAB NA-21 and ADK STAB NA-71 by Adeka Palmarole. The crystal nucleating agents therein may be used as individual components or in combinations of two or more.

In some embodiments, the compositions described herein have an intrinsic viscosity of the xylene soluble fraction (XSIV) at room temperature from 0.1 to 1.3 dl/g, such as from 0.5 to 1.3 dl/g and from 0.5 to 1.2 dl/g.

In additional embodiments, the compositions described herein have a melt flow rate (MFR), measured at 230° C. and 2.16 kg, from 35 to 60 g/10 min, including from 40 to 50 g/10 min.

When the polymer component (a) is a copolymer of propylene, it may contain up to 1.0 wt. %, such as up to 0.5 wt. %, of ethylene derived units.

The polymerization stages may occur in liquid phase, in gas phase or liquid-gas phase. In certain embodiments, the polymerization of the polymer component (a) is carried out in a liquid monomer (e.g., using liquid propylene as a diluent), while the copolymerization stages of the copolymer component (b) may be carried out in gas phase. Alternatively, all the sequential polymerization stages can be carried out in gas phase.

The reaction temperature in the polymerization stage for the preparation of the polymer component (a) and for the preparation of the copolymer component (b) may be the same or different, and may be performed at a temperature from 40 to 100° C. In certain embodiments, the reaction temperature ranges from 50 to 90° C. for the preparation of polymer component (a), and from 70 to 100° C. for the preparation of polymer component (b).

The pressure of the polymerization stage to prepare polymer component (a), if carried out in liquid monomer, is the one which competes with the vapor pressure of the liquid propylene at the operating temperature used, and it may be modified by the vapor pressure of the small quantity of inert diluent used to feed the catalyst mixture, by the overpressure of optional monomers and using hydrogen as a molecular weight regulator.

In some embodiments, the polymerization pressure y ranges from 33 to 45 bar in liquid phase, and from 5 to 30 bar in gas phase. The residence times relative to the stages depend on the desired ratio between polymer components (a) and (b), and may range from 15 minutes to 8 hours. Conventional molecular weight regulators known in the art, such as chain transfer agents (e.g. hydrogen or diethyl zinc (ZnEt₂)), may be used.

The compositions disclosed herein can also be obtained by separately preparing components (a) and (b) by operating with similar catalysts and polymerization conditions as described above (except that the components are prepared in separate polymerization steps) and then mechanically blending the components in a molten or softened state. Conventional mixing apparatuses, like screw extruders such as twin screw extruders, can be used.

All the polymerization stages are suitably carried out in the presence of a catalyst comprising a trialkylaluminum compound, optionally comprising an electron donor, a solid catalyst component comprising a halide or halogen-alcoholate of Ti and an electron-donor compound supported on anhydrous magnesium chloride. Catalysts having the above mentioned characteristics are known in the patent literature, including the catalysts described in U.S. Pat. No. 4,399,054 and EP Pat. No. 45977. Other examples can be found in U.S. Pat. No. 4,472,524.

In some embodiments, the polymerization catalyst is a stereospecific Ziegler-Natta catalyst comprising:
(i) a solid catalyst component comprising Mg, Ti, halogen and an electron donor (internal donor);
(ii) an alkyl aluminum compound (co-catalyst); and
(iii) optionally, an electron-donor compound (as anexternal donor).

The internal donor may be selected from esters of mono or dicarboxylic organic acids, such as benzoates, malonates, phthalates and succinates as described, for example, in U.S. Pat. No. 4,522,930, EP Pat. No. 45977, and WIPO Pat. Nos. WO 00/63261 and WO 01/57099. In additional embodiments, phthalic acid esters such as alkylphthalates, diisobutyl-phthalate, dioctyl-phthalate, diphenyl-phthalate and benzyl-butyl-phthalate, and succinate acids esters may be used.

In certain embodiments, internal donors for use in the present technology include succinate-type compounds of formula (I) below:

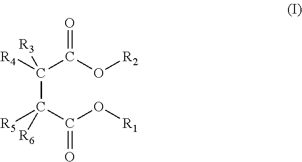

wherein the radicals R₁ and R₂, equal to or different from each other, are selected from C1-C20 linear or branched alkyl, alkenyl, cycloalkyl, aryl, arylalkyl and alkylaryl group, optionally containing heteroatoms; the radicals R₃ to R₆, equal to or different from each other, are selected from hydrogen, a C1-C20 linear or branched alkyl, alkenyl, cycloalkyl, aryl, arylalkyl and alkylaryl group, optionally containing heteroatoms, and any two of the R₃ to R₆ radicals can be linked together to form a cyclic compound.

The alkyl aluminum compounds used as co-catalysts comprise aluminum (Al) compounds including Al-trialkyls, such as Al-triethyl, Al-triisobutyl and Al-tri-n-butyl, and linear or cyclic Al-alkyl compounds containing two or more Al atoms bonded to each other by O or N atoms, or SO₄ or SO₃ groups. The Al-alkyl compound may be used in such a quantity that the Al/Ti ratio is from about 1 to about 1000.

In some embodiments, the external donor can the same type or different from the succinates of the general formula (I). In certain embodiments, external electron-donor compounds include silicon compounds, ethers, esters such as phthalates, benzoates, succinates also having a different structure from those of formula (I), amines, heterocyclic compounds including 2,2,6,6-tetramethylpiperidine, ketones and 1,3-diethers of the general formula (II):

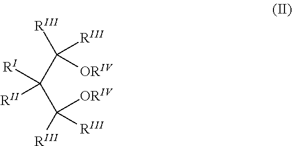

wherein R¹ and R¹¹ are the same or different and are selected from C1-C18 alkyl, C3-C18 cycloalkyl and C7-C18 aryl radicals; R^{III} and R^{IV} are the same or different and are C1-C4 alkyl radicals; and 1,3-diethers in which the carbon atom in position 2 comprises a cyclic or polycyclic structure comprising 5, 6 or 7 carbon atoms and containing two or three sites of unsaturation.
Ethers of this type are described, for instance, in EP Pat. Nos. EP361493 and EP728769.

In some embodiments, electron-donor compounds that can be used as external donors include aromatic silicon compounds containing at least one Si—OR bond, where R is a hydrocarbon radical. External donor compounds for use in the present technology include silicon compounds of the general formula (R₅)ₐ(R₆)_{b}Si(OR₇)_{c}, where a and b are integers from 0 to 2, c is an integer from 1 to 4, and the sum (a+b+c) is 4; and R₅, R₆, and R₇ are C1-C18 hydrocarbon groups optionally containing heteroatoms. In additional embodiments, silicon compounds in which a is 1, b is 1, c is 2; at least one of R₅ and R₆ is selected from a branched alkyl, alkenyl, alkylene, cycloalkyl and aryl groups with 3-10 carbon atoms optionally containing heteroatoms; and R₇ is a C1-C10 alkyl group may be used. Examples of silicon compounds for use in the present disclosure include cyclohexyltrimethoxysilane, t-butyltrimethoxysilane, t-hexyltrimethoxysilane, cyclohexylmethyldimethoxysilane, 3,3,3-trifluoropropyl-2-ethylpiperidyl-dimethoxysilane, diphenyldimethoxysilane, methyl-t-butyldimethoxysilane, dicyclopentyldimethoxysilane, 2-ethylpiperidinyl-2-t-butyldimethoxysilane, (1,1,1-trifluoro-2-propyl)-methyldimethoxysilane and (1,1,1-trifluoro-2-propyl)-2-ethylpiperidinyldimethoxysilane. Moreover, silicon compounds in which a is 0, c is 3, R₆ is a branched alkyl or cycloalkyl group, optionally containing heteroatoms, and R₇ is methyl may be used. Additional examples of silicon compounds for use in the disclosed technology are (tert-butyl)₂Si(OCH₃)₂, (cyclohexyl)(methyl) Si(OCH₃)₂, (phenyl)₂Si(OCH₃)₂, (cyclopentyl)₂Si(OCH₃)₂, and di-iso-propyl-di-methoxi-silane.

In some embodiments, the external electron donor compound is used in such an amount to give a molar ratio between the organo-aluminum compound and the electron donor compound from 0.1 to 500, such as from 1 to 300 and from 3 to 30.

In additional embodiments, the catalyst may comprise more than one internal donor as well as more than one external donor.

The solid catalyst component may comprise, in addition to the above referenced electron donors, Ti, Mg and halogens. In some embodiments, the catalyst component comprises a titanium compound having at least a Ti-halogen bond, and the above referenced electron donor compounds are supported on a magnesium (Mg) halide composition. The magnesium halide may comprise MgCl₂ in active form, which is known as a support for Ziegler-Natta catalysts. For instance, U.S. Pat. Nos. 4,298,718 and 4,495,338 describe the use of these compounds in Ziegler-Natta catalysis.

In certain embodiments, titanium compounds include TiCl₄ and TiCl₃. Ti-haloalcoholates of formula Ti(OR)_{n-y}X_{y} may also be used, where n is the valence of titanium, y is a number between 1 and n, X is halogen and R is a hydrocarbon radical having from 1 to 10 carbon atoms.

The preparation of the solid catalyst component can be carried out according to methods known in the art.

In some embodiments, the method comprises a solid catalyst component that can be prepared by reacting a titanium compound of the formula Ti(OR)_{n-y}X_{y}, where n is the valence of titanium and y is a number between 1 and n, such as TiCl₄, with a magnesium chloride deriving from an adduct of formula MgCl₂.pROH, where p is a number between 0.1 and 6, including from 2 to 3.5, and R is a hydrocarbon radical having 1-18 carbon atoms. The adduct can be prepared in spherical form by mixing alcohol and magnesium chloride in the presence of an inert hydrocarbon that is immiscible with the adduct under stirring conditions at the melting temperature of the adduct (100-130° C.). The emulsion is then quickly quenched, thereby causing the solidification of the adduct in the form of spherical particles.

Examples of spherical adducts prepared according to this procedure are described in U.S. Pat. Nos. 4,399,054 and 4,469,648. The resulting adduct can be directly reacted with the Ti compound or it can be subjected to thermally controlled dealcoholation (80-130° C.) to produce an adduct in which the number of moles of alcohol is generally lower than 3, such as between 0.1 and 2.5. The reaction with the Ti compound can be carried out by suspending the adduct (dealcoholated or commercially prepared) in cold TiCl₄ (generally at a temperature of about 0° C.). The mixture is heated up to 80-130° C. and kept at this temperature for 0.5-2 hours. The treatment with TiCl₄ can be carried out one or more times. The electron donor compound(s) can be added during the treatment with TiCl₄.

Regardless of the preparation method used, in certain embodiments the final amount of the electron donor compound(s) is such that the molar ratio with respect to the MgCl₂ is from 0.01 to 1, such as from 0.05 to 0.5.

Catalyst components and catalysts of this type are described, for instance, in WIPO Pat. App. Pub. Nos. WO 00/63261 and WO 01/57099.

In some embodiments, the catalysts may be precontacted with small quantities of olefin (“prepolymerization”), maintaining the catalyst in suspension in a hydrocarbon solvent, and polymerizing at temperatures from ambient (about 20-25° C. to 60° C., from producing a quantity of polymer from 0.5 to 3 times the weight of the catalyst. The operation can also take place in liquid monomer that, in some embodiments, results in a quantity of polymer 1000 times the weight of the catalyst.

By using the above referenced catalysts, the polyolefin compositions may be obtained in spheroidal particle form and may comprise an average diameter from about 250 to 7,000 micrometers (μm), a flowability of less than 30 seconds and a bulk density (compacted) greater than 0.4 g/ml.

Besides the nucleating agent, the compositions disclosed herein can contain other additives known in the art, such as antioxidants, light stabilizers, heat stabilizers, colorants and fillers.

The addition of inorganic fillers, such as talc, calcium carbonate and mineral fibers, may improve some mechanical properties of the resulting polymers, such as flexural modulus and heat deflection temperature (HDT).

The compositions disclosed herein can be used to prepare molded articles comprising excellent impact behavior.

Molded articles comprising the compositions described herein exhibit excellent impact properties, including at low temperatures, and are suitable for use as food containers, e.g. containers for storing food in a refrigerator.

The following examples are given to illustrate embodiments of the present disclosure.

### Examples

Methods

Ethylene Content

The content of ethylene comonomer is determined by infrared (IR) spectroscopy by collecting the IR spectrum of the sample versus an air background with a Fourier transform infrared spectrometer (FTIR). The instrument data acquisition parameters are:
Purge time: 30 seconds minimum
Collection time: 3 minutes minimum
Apodization: Happ-Genzel
Resolution: 2 cm⁻¹.

Sample Preparation—Using a hydraulic press, a thick sheet is obtained by pressing about 1 g of sample between two aluminum foil sheets. A small portion is cut from one of the sheets to mold a film. The recommended film thickness ranges between 0.02 and 0.05 cm (8-20 mils). The pressing temperature is about 180±10° C. (356° F.) and about 10 kg/cm² (142.2 PSI) of pressure for about one minute. After the pressure is released, the sample is removed from the press and cooled to room temperature.

The spectrum of pressed film sample is recorded as a function of absorbance versus wavenumbers (cm⁻¹). The following measurements are used to calculate ethylene content:
Area (At) of the combination absorption bands between 4482 and 3950 cm⁻¹, which is used for spectrometric normalization of film thickness;
Area (AC2) of the absorption band between 750-700 cm⁻¹ after a spectroscopic subtraction of a reference spectrum of an isotactic, non-additivated polypropylene in the range of 800-690 cm⁻¹.

In order to calculate the ethylene content, a calibrated straight line for ethylene obtained by using samples of known amount of ethylene is produced by plotting AC2/At versus ethylene molar percent (% C2m). The slope GC2 is calculated from a linear regression.

The spectra of the unknown samples are recorded and (At) and (AC2) of the unknown sample are calculated. The ethylene content by weight is obtained by converting from the ethylene content (% molar fraction C2m) of the sample, which is calculated as follows:

$$\% C 2 m = \frac{1}{{G}_{C 2 }} \cdot \frac{{A}_{C 2}}{{A}_{t}}$$

The ethylene content of component (a) was determined on a propylene copolymer sample taken out of the first reactor.

The ethylene content of component (b) was determined using the precipitated “amorphous “fraction” of the polymer. The precipitated “amorphous fraction was obtained as follows: to one 100 ml aliquot of the filtered liquid obtained as described below in the paragraph headed “Intrinsic viscosity of the xylene-soluble fraction,” 200 ml of acetone were added under vigorous stirring. The precipitation is completed when a clear solid-solution separation is observed. The resulting solid was filtered on a metallic screen and dried in a vacuum oven at 70° C. until a constant weight was reached. Since the portion of (b) with very high ethylene content crystallizes and is excluded from the xylene-soluble fraction, a correction was made to the ethylene content of the “amorphous” fraction by using the following equation obtained from the data of copolymers of ethylene with propylene polymerized in an autoclave by using the same catalyst systems:

(ethylene content of component (b))=1.37×(ethylene content of “amorphous” fraction)−5.7

The above equation is valid when the ethylene content of “amorphous” is between about 50% and about 70% by weight (the ethylene content of (b) is between about 63% and about 90% by weight).

Determination of the Intrinsic Viscosity of the Xylene-Soluble Fraction (XSIV):

2.5 g of polymer and 250 ml of xylene were introduced in a glass flask equipped with a refrigerator and a magnetic stirrer. The temperature is raised over a 30 minute period up to the boiling point of the solvent. The resulting clear solution is then kept under reflux and stirring for 30 minutes and the closed flask is then kept in a thermostatic water bath at about 25° C. for 30 minutes. The resulting solid is filtered on quick filtering paper. A 100 ml aliquot of the filtered liquid was poured in an aluminum container and heated on a heating plate under nitrogen flow to remove the solvent by evaporation. The sample selected for the measurement was removed from the container after cooling for 30 minutes at room temperature. The intrinsic viscosity was determined in tetrahydronaphthalene at 135° C.

Melt Flow Rate (MFR):

Determined according to ISO 1133 (230° C., 2.16 Kg).

Haze:

Determined according to ASTM D10003-61. 5×5 cm specimens are cut from molded plaques of 1 mm thick, and their haze value is measured using a Gardner photometric unit connected to a Hazemeter type UX-10 or an equivalent instrument having a G.E.1209 light source with filter “C”. Reference samples of known haze are used for calibrating the instrument. The plaques to be tested are produced according to the following method. 75×75×1 mm plaques are molded with a GBF Plastinjector G235/90 Injection Molding Machine, set at 90 tons and operated under the following processing conditions:
Screw rotation speed—120 rpm
Back pressure—10 bar
Melt temperature—260° C.
Injection time—5 sec
Switch to hold pressure—50 bar
First stage hold pressure—30 bar
Second stage pressure—20 bar
Hold pressure profile, 1st stage—5 sec
Hold pressure profile, 2nd stage—10 sec
Cooling time—20 sec
Mold water temperature—40° C.

Flexural Modulus:

Determined according to ISO 178.

Puncture Resistance at −20° C.:

Determined by using Hydroshot HITS-T10 (Shimadzu Corporation) for plaques produced according to the following method. 130×130×2 mm plaques are molded with an injection molding machine (Fanuc Corporation) under 230° C. of melt temperature and 500 bar of hold pressure.

Spiral Flow:

Determined by measuring the spiral length of injection molded articles with a mold of Archimedes spiral having a trapezoidal cross-section (upper bottom: 9.5 mm, lower bottom: 10 mm, height: 1 mm) of flow channel. The spiral articles to be tested are molded with a α 100 C Injection Molding Machine (Fanuc Corporation) under the following processing conditions:
Melt temperature—250° C.
Injection pressure—765 bar
Injection speed—10 mm/sec
Hold pressure—735-745 bar
Hold pressure time—3 sec
Cooling time—10 sec
Mold water temperature—40° C.

### EXAMPLES

A series of polymerization runs were carried out in a plant operating continuously in a series of a first liquid-phase reactor and a second fluidized bed gas-phase reactor, equipped with devices to transfer the product from the first to the second reactor.

### Comparative Examples 1 and 2C

Preparation of the Catalyst and Pre-Polymerization:

A Ziegler-Natta catalyst component was prepared according to Example 5, lines 48-55 of EP Pat. Doc. EP728769. The resulting catalyst component was contacted at 12° C. for 24 minutes with triethyl aluminum (TEAL) and dicyclopentyldimethoxysilane (DCPMS) as an outside-electron-donor component. The weight ratio between TEAL and the solid catalyst component was 20 and the weight ratio between TEAL and DCPMS was 10. The resulting catalyst system was subjected to pre-polymerization by maintaining it in a liquid propylene suspension at 20° C. for about 5 minutes before introducing it into the first polymerization reactor.

Polymerization

A propylene homopolymer comprising component (a) was prepared in the first reactor, while an ethylene-propylene copolymer comprising component (b) was prepared in the second reactor. The temperature and pressure were constantly maintained throughout the reaction. Hydrogen was used as molecular weight regulator. The composition of the gas phase (propylene, ethylene and hydrogen) was continuously monitored by gas-chromatography analysis. At the end of the run the powder is discharged and dried under a nitrogen flow. Data on the polymerization conditions for the liquid-phase and gas-phase reactor and on the characterization of the polymer obtained therefrom are shown in Tables 1 and 2, respectively. The polymer characterization data are obtained from measurements carried out on the resulting polymers and stabilized as necessary.

Extrusion:

The polymer particles were then introduced in an extruder, wherein they were mixed with:
2000 ppm of 1,3:2,4-bis(3,4-dimethylbenzylidene) sorbitol, a clarifying agent marketed by Milliken™ under the name Millad® 3988,
0.10 wt. % of an antioxidant marketed by BASF™ under the name Irganox® B225, and
0.05 wt. % of calcium stearate.

The polymer particles were then extruded under a nitrogen atmosphere in a twin screw extruder at a rotation speed of 220 rpm and a melt temperature of 200-250° C. Data relating to the physical-mechanical properties of the final polymer compositions, obtained from measurements carried out on the resulting polymers, are reported in Table 3.

### Example 3, Comparative Examples 4C and 5C

The procedure described for Examples 1 and 2C was repeated with the difference that the Ziegler-Natta catalyst was prepared according to Example 1 of WIPO Pat. App. Pub. No. WO 2009/050045 except that, for the first temperature increase, the temperature was raised to 110° C. instead of 100° C. For Comparative Example 5C no clarifying agent (Millad® 3988) was mixed with the polymer particles for extrusion. Data on the polymerization conditions for the liquid-phase and gas-phase reactor and on the characterization of the polymer obtained therefrom are shown in Table 1 and Table 2 respectively. Data relating to the physical-mechanical properties of the final polymer compositions, obtained from measurements carried out on the resulting polymers, are reported in Table 3.

TABLE 1
Liquid phase polymerization

| | | EXAMPLE | | | | |
|---|---|---|---|---|---|---|
| | | 1 | 2C | 3 | 4C | 5C |
| Temperature | ° C. | 75 | 75 | 75 | 75 | 75 |
| Pressure | MPa | 39.4 | 39.4 | 39.5 | 39.5 | 39.5 |
| Residence time | min | 60 | 60 | 90 | 90 | 90 |
| H2 conc on feed | ppm | 8300 | 8200 | 6700 | 6500 | 6700 |

TABLE 2
Gas phase polymerization

| | | EXAMPLE | | | | |
|---|---|---|---|---|---|---|
| | | 1 | 2C | 3 | 4C | 5C |
| Temperature | ° C. | 80 | 80 | 80 | 80 | 80 |
| Pressure | MPa | 16 | 16 | 14 | 14 | 14 |
| Residence time | min | 35 | 27 | 33 | 30 | 33 |
| H2/C2 | mol ratio | 0.66 | 0.6 | 0.5 | 0.4 | 0.5 |
| C2/(C2 + C3) | mol ratio | 0.82 | 0.79 | 0.71 | 0.70 | 0.71 |
| Component (b) | wt % | 27 | 23 | 25 | 25 | 25 |
| C2 in comp. (b) | wt % | 77 | 78 | 77 | 76 | 77 |
| XSIV | dl/g | 1.1 | 1.0 | 1.1 | 1.4 | 1.1 |
| MFR | g/10 min | 49 | 42 | 41 | 35 | 41 |

TABLE 3
Properties of the compositions

| | | EXAMPLE | | | | |
|---|---|---|---|---|---|---|
| | | 1 | 2C | 3 | 4C | 5C* |
| Haze | % | 25 | 24 | 28 | 37 | 40 |
| Flex. Mod. | MPa | 1380 | 1420 | 1510 | 1530 | 1320 |
| Puncture | J | 8.0 | 0.9 | 7.9 | 10.9 | 7.0 |
| Resistance | | | | | | |
| Spiral flow | cm | 32.7 | 31.8 | 33.2 | 32.3 | 33.3 |

*No Millad 3988 used

What is claimed is:

1. A propylene polymer composition comprising:
(a) 68-76 wt. %, based upon the total weight of components (a) to (c), of a first polymer component comprising a propylene homopolymer or a copolymer of propylene, wherein the propylene copolymer contains up to 1.2 wt. %, of ethylene derived units;
(b) 24-32 wt. %, based upon the total weight of components (a) to (c), of a second polymer component comprising a copolymer comprising 72 to 86 wt. % ethylene derived units and 14 to 28 wt. % propylene derived units; and
(c) a nucleating agent;
wherein the polypropylene composition has an intrinsic viscosity of the xylene soluble fraction (XSIV) at room temperature of up to 1.3 dl/g and a melt flow rate (MFR), measured at 230° C. and 2.16 kg, from 30 to 70 g/10 min.

2. The propylene polymer composition of claim 1, wherein the nucleating agent is present in amount from 0.01 to 2% by weight, based upon the total weight of components (a) to (c).

3. The propylene polymer composition of claim 1, wherein the nucleating agent is selected from the group consisting of talc, 1,3:2,4-dibenzylidenesorbitol, 1,3:2,4-bis-(4-methylbenzylidene) sorbitol, 1,3:2,4-bis-(3,4-dimethylbenzylidene sorbitol), 1,2,3-trideoxy-4,6:5,7-bis-O-[(4 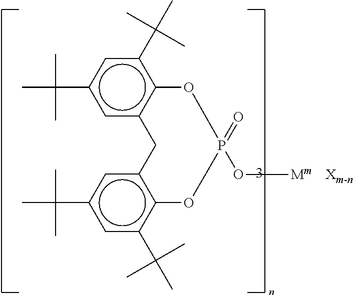
propylphenyl)methylene]-nonitol, 1,3,5-tris(2,2-dimethylpropionylamino)benzene, and phosphoric esters of the formula:
wherein M is aluminum, X is a hydroxy group, m is 3, and n is 1 or 2.

4. A process for the preparation of the polyolefin compositions of claim 1, comprising at least two sequential polymerization stages, with each subsequent polymerization being conducted in the presence of the polymeric material formed in the immediately preceding polymerization reaction, wherein the polymerization stage of propylene to the polymer component (a) is carried out in at least one stage, then at least one copolymerization stage of mixtures of ethylene with propylene to the polymer component (b) is carried out.

5. The process of claim 4, wherein the poymerization stages are carried out in the presence of a stereospecific Ziegler-Natta catalyst.

6. The process of claim 4, wherein the stereospecific Ziegler-Natta catalyst comprises:
(i) a solid catalyst component comprising Mg, Ti, halogen and an electron donor (internal donor);
(ii) an aluminium-alkyl compound (co-catalyst); and
(iii) optionally an electron-donor compound (external donor).

7. The process of claim 4, wherein the polymerization of polymer component (a) is carried out in a liquid monomer, and the copolymerization stages of copolymer component (b) is carried out in gas phase.

8. A molded article comprising the propylene polymer composition of claim 1, comprising:
(a) 68-76 wt. %, based upon the total weight of components (a) to (c), of a first polymer component comprising a propylene homopolymer or a copolymer of propylene, wherein the copolymer of propylene contains up to 1.2 wt. %, of ethylene derived units;
(b) 24-32 wt. %, based upon the total weight of components (a) to (c), of a second polymer component being a copolymer comprising 72 to 86 wt. % ethylene derived units and 14 to 28 wt. % propylene derived units; and
(c) a nucleating agent;
wherein the polypropylene composition has an intrinsic viscosity of the xylene soluble fraction (XSIV) at room temperature up to 1.3 dl/g and a melt flow rate (MFR), measured at 230° C. and 2.16 kg, from 30 to 70 g/10 min.

9. The molded article of claim 8, comprising a container.
